(19) United States
(12) Patent Application Publication
(10) Pub. No.: US 2013/0021455 A1
(43) Pub. Date: Jan. 24, 2013

(54) VIDEO DISPLAY DEVICE AND VIDEO DISPLAY METHOD

(71) Applicant: Yukihiro SASAZAKI, Tokyo (JP)

(72) Inventor: Yukihiro SASAZAKI, Tokyo (JP)

(21) Appl. No.: 13/547,258

(22) Filed: Jul. 12, 2012

(30) Foreign Application Priority Data
Jul. 19, 2011 (JP) 2011-158327

(51) Int. Cl. H04N 13/04

(52) U.S. Cl. 348/51; 348/E13.059

(57) ABSTRACT

A video display device includes a first terminal unit that receives video data that is outputted by a source device and transmits data about a format of video data that can be inputted, to the source device, a video data processing unit that display-processes the video data, a display unit that displays an image based on the video data, a data storage unit that stores data about video data that can be inputted, a second terminal unit that outputs synchronization data for performing three-dimensional display on the display unit, and a control unit that performs control of storing data indicating that video data for three-dimensional display can be inputted, in the data storage unit when an external device is connected to the second terminal unit, and control of storing data indicating that input of video data for three-dimensional display is not permitted when the external device is not connected.

### BACKGROUND

The present disclosure relates to a video display device and a video display method that are favorably applied to a projection type video display device which displays a stereoscopic image, for example.

There is a projection type video display device which projects an image on a screen to permit a user who looks at the screen to recognize a three-dimensional. image (stereoscopic image). This projection type video display device (projector device) displays images for a left eye and images for a right eye on the screen while switching the images alternately in a predetermined cycle (field cycle, for example). Then, the user watches the displayed images through stereoscopic image observation glasses such as liquid crystal shutter glasses of which opening and closing of opening/closing parts corresponding to right and left eyes are controlled in synchronization with a display state of images.

As a technique for supplying a signal for controlling opening and closing of the opening/closing parts (=synchronization signal) to the stereoscopic image observation glasses, a technique to transmit infrared rays including a synchronization signal from an emitter device (opening/closing control device) which is connected with a projector device to the stereoscopic image observation glasses is widely employed.

Japanese Unexamined Patent Application Publication No. 9-9299 (FIG. 1) discloses a stereoscopic image display system for observing a stereoscopic image by using liquid crystal shutter glasses. Further, Japanese Unexamined Patent Application Publication No. 9-9299 (FIG. 1) discloses that a synchronization code of infrared rays is transmitted to the liquid crystal shutter glasses.

### SUMMARY

Such projection type video display device which displays a stereoscopic image can transmit a synchronization code with respect to liquid crystal shutter glasses in a state that an emitter device is connected to the projection type video display device, thus correctly functioning as a stereoscopic image display device. However, in a state that an emitter device is not connected to the projection type video display device, liquid crystal shutter glasses do not operate even though the projection type video display device alternately displays images for a left eye and images for a right eye on a screen. Thus, stereoscopic image viewing is difficult. Therefore, in a case where video data for stereoscopic viewing is inputted into the video display device in a state that the emitter device is not connected to the video display device, it is necessary that the inputted video data for stereoscopic viewing is forcibly converted into normal video data for 2D display.

However, when video data for stereoscopic viewing is converted into video data for 2D display in the video display device as described above, displayed image is deteriorated due to the conversion. Accordingly, it is preferable to prevent the conversion from video data for stereoscopic viewing into video data for 2D display in the video display device. Though the example of the video display device as a projector device has been described thus far, there is a similar problem in a case where stereoscopic viewing is performed by connecting an emitter device to a normal video display device which displays an image on a display panel.

It is desirable to provide a video display device and a video display method by which appropriate display processing can be performed according to a state of the video display device which can perform display processing for stereoscopic viewing.

A video display device according to an embodiment of the present disclosure includes a first terminal unit which receives video data that is outputted by a source device and transmits data about a format of video data that can be inputted, to the source device. The video display device further includes a data storage unit that stores data, which is outputted by the first terminal unit, about video data which can be inputted, a second terminal unit that outputs synchronization data for performing three-dimensional display on the display unit, and a control unit that controls storage of the data storage unit in accordance with a connection state of the second terminal unit.

As the control of the data storage unit by the control unit, data indicating that video data for three-dimensional display can be inputted is stored in the data storage unit in a case where an external device is connected to the second terminal unit. Further, in a case where the external device is not connected to the second terminal unit, data indicating that input of video data for three-dimensional display is not permitted is stored in the data storage unit.

In a video display method according to another embodiment of the present disclosure, first communication processing in which video data outputted by a source device is inputted via a first terminal unit and data about a format of video data that can be inputted is read out at the first terminal unit from a data storage unit so as to be outputted to the source device is performed. Then, display processing in which display based on the video data that is obtained from the source device in the first communication processing is performed is performed. Further, second communication processing in which synchronization data for performing three-dimensional display in the display processing is outputted to an external device is performed. Further, control processing in which storage of the data storage unit is controlled in accordance with a connection state of the second terminal unit is performed.

As the control processing, data indicating that video data for three-dimensional display can be inputted is stored in the data storage unit in a case where an external device that performs the second communication processing is connected. Further, data indicating that input of video data for three-dimensional display is not permitted is stored in the data storage unit in a case where the external device is not connected.

Accordingly, data, which is transmitted to the source device by the first terminal unit, about a format of video data which can be inputted changes depending on a connection state of the second terminal unit. That is, when a device used for stereoscopic viewing is connected to the second terminal unit, data, which is transmitted to the source device by the first terminal unit, about a format of video data which can be inputted becomes data indicating that video data for three-dimensional display can be inputted. Further, when a device used for stereoscopic viewing is not connected to the second terminal unit, data, which is transmitted to the source device by the first terminal unit, about video data which can be inputted becomes data indicating that input of video data for three-dimensional display is not permitted.

According to the embodiments of the present disclosure, data, which is transmitted to the source device by the first terminal unit, about a format of video data which can be inputted changes in accordance with a connection state of the second terminal unit. Due to the change in accordance with the connection state, a state that three-dimensional display is possible and a state that three-dimensional display is not permitted can be appropriately automatically set in accordance with a state of the device.

### BRIEF DESCRIPTION OF THE DRAWINGS

FIG. 1 is a block diagram illustrating a configuration example of a video display device according to an embodiment of the present disclosure;

FIG. 2 is a block diagram illustrating a configuration example of a transmission side and a reception side via a HDMI cable according to the embodiment of the present disclosure;

FIG. 3 illustrates an example that an emitter device is connected to the video display device according to the embodiment of the present disclosure;

FIG. 4 illustrates an example of a transmission state via a LAN cable according to the embodiment of the present disclosure; and

FIG. 5 is a flowchart illustrating a setting processing example of extended display identification data (EDID) according to the embodiment of the present disclosure.

### DETAILED DESCRIPTION OF EMBODIMENTS

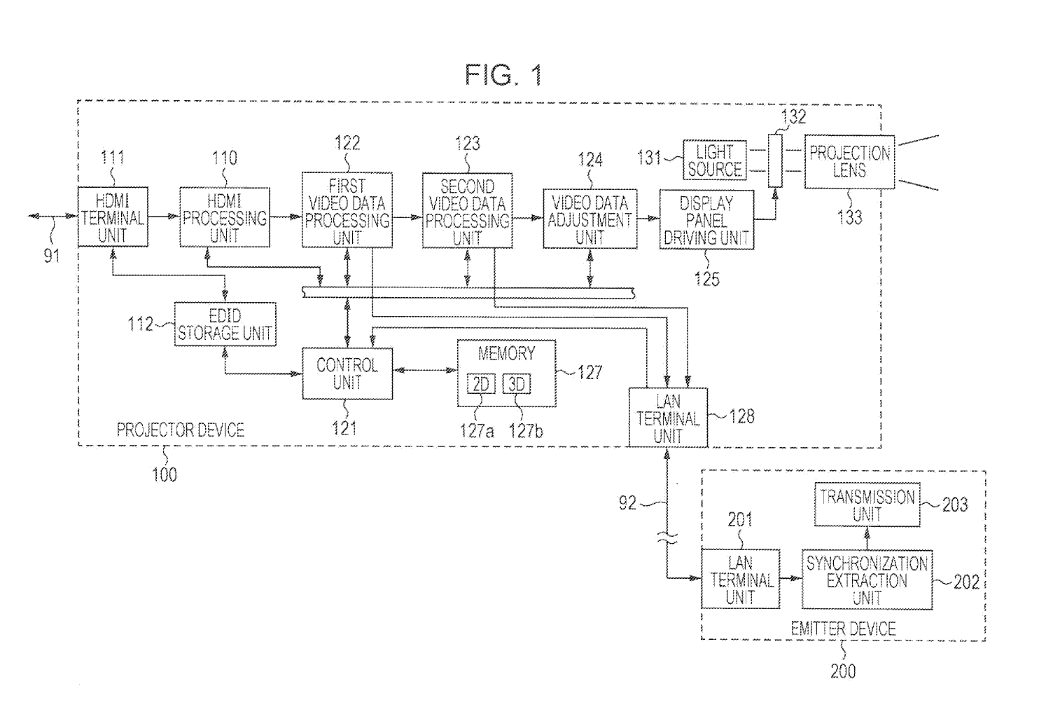

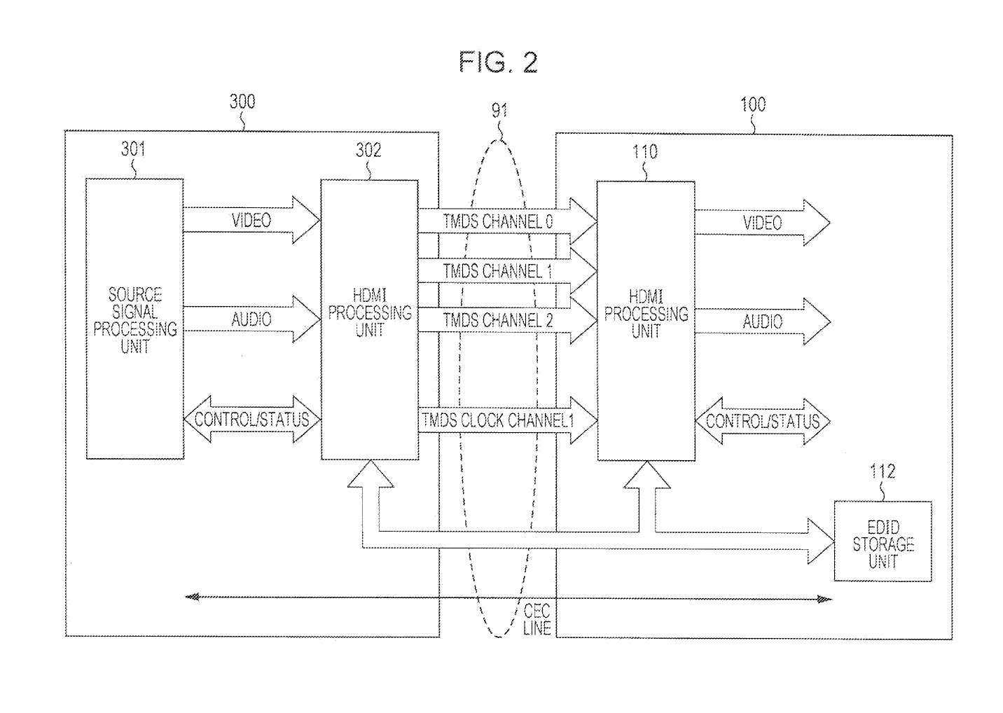

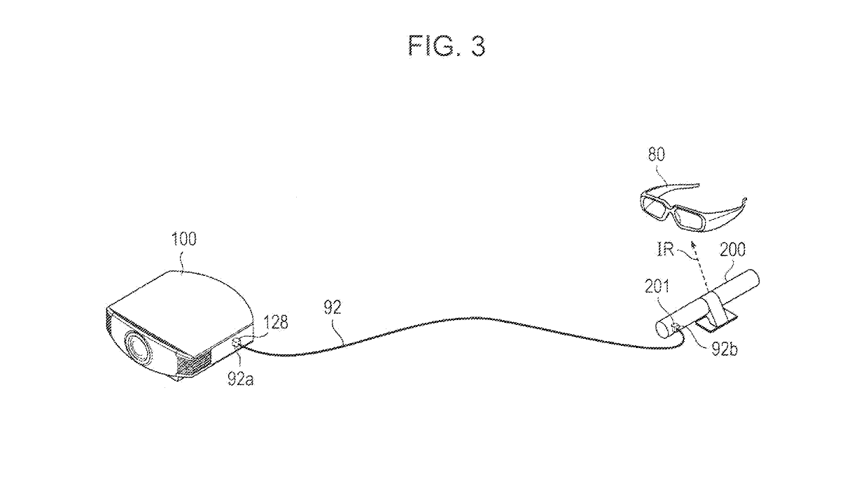

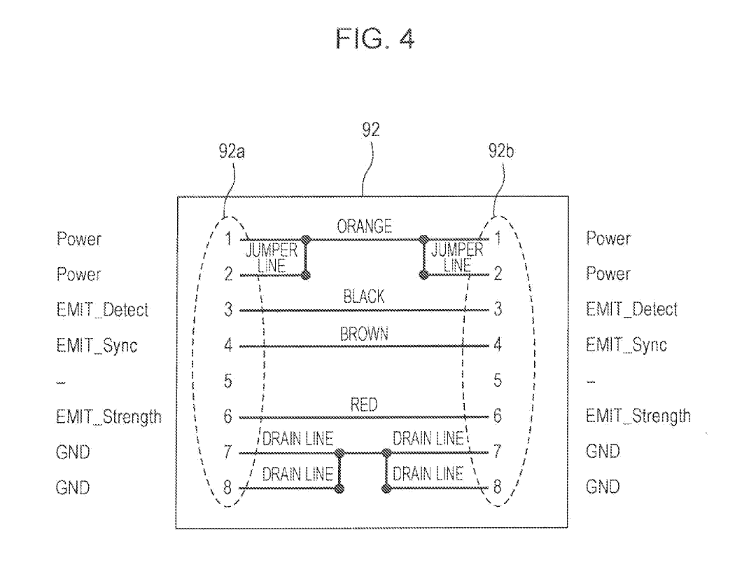

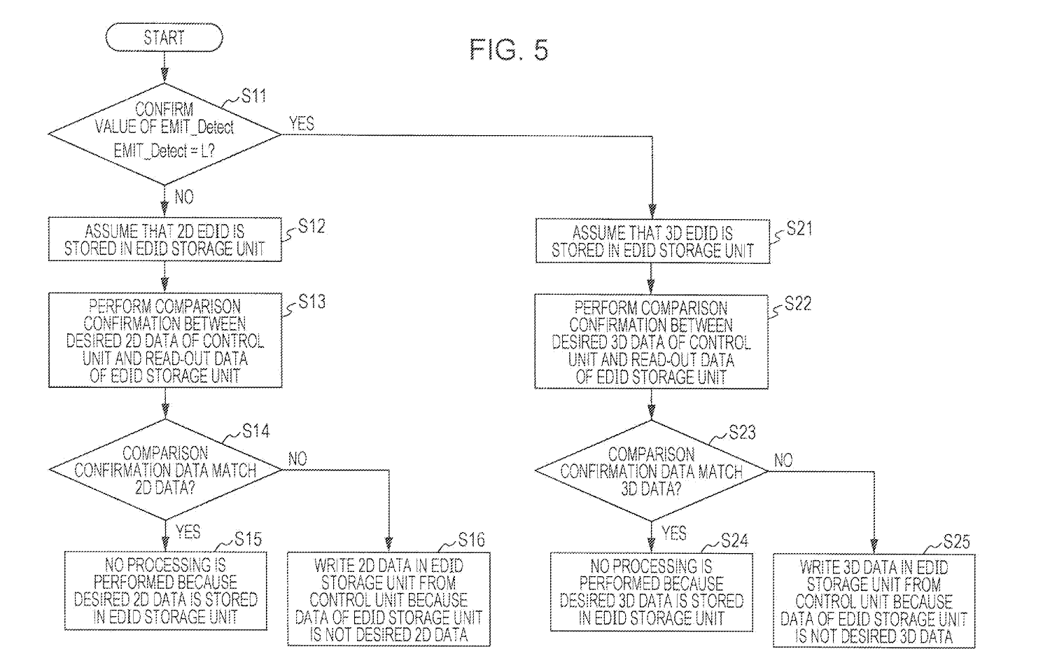

An embodiment of the present disclosure will be described in the following order.
1. Configuration of Video Display Device (FIG. 1)
2. Configuration for Transmitting/Receiving via HDMI Cable (FIG. 2)
3. Connecting Configuration of Video Display Device and Emitter Device (FIGS. 3 and 4)
4. Setting Processing of EDID (FIG. 5)
5. Modification

### [1. Configuration of Video Display Device] (FIG. 1)

FIG. 1 illustrates the configuration of a video display device according to an example of an embodiment of the present disclosure. The example of the embodiment is an example of an application to a projector device which projects an image on a screen and serves as a video display device. The video display device (projector device) of the embodiment of the present disclosure is a device capable of three-dimensional display, and when inputted video data is video data for three-dimensional display, the video display device performs corresponding processing. However, there is a case where the video display device is limited to be in a state that the video display device performs only normal two-dimensional display, in accordance with a state of the video display device, as described later.

A projector device 100 depicted in FIG. 1 includes a high-definition multimedia interface (HDMI) terminal unit 111. This HDMI terminal unit 111 is a terminal unit of the digital image and sound input/output interface standard which is called the HDMI standard. In the HDMI standard, a device on an output side of an image and sound is called a source device and a device on an input side of an image and sound is called a sink device.

The HDMI terminal unit 111 of the projector device 100 is a terminal unit of a sink device, that is, a terminal unit on a side of inputting an image and sound. The HDMI terminal unit 111 performs not only input of video data and audio data but also input/output of various types of control data and status data. Though concrete details of the data transmission channel configuration will be described later, one of data which are transmitted from the sink device to the source device is data about a format of video data which can be inputted. A HDMI terminal unit on the source device side identifies the data about a format of video data which can be inputted and the HDMI terminal unit of the source device outputs video data and audio data in a format by which the sink device can input the data.

To the HDMI terminal unit 111 of the projector device 100, a HDMI processing unit 110 is connected. This HDMI processing unit 110 performs transmission processing as a sink device. Further, to the HDMI terminal unit 111, an extended display identification data (EDID) storage unit 112 is connected. The EDID storage unit 112 stores data about a format of video data which can be inputted into the projector device 100 serving as the sink device. The source device reads out the data which is stored in the EDID storage unit 112.

The EDID storage unit 112 is composed of a nonvolatile memory which is an electrically erasable programmable read-only memory (EEPROM), for example. The EEPROM is used as an example, and other memory may be used as long as the memory is a nonvolatile memory in which storage data is maintained. Here, a memory constituting the EDID storage unit 112 is a memory of relatively-low capacity such as 256 bites, so that the EDID storage unit 112 can be inexpensively configured by using the EEPROM. Further, it is necessary to rewrite data of the EDID storage unit 112 as described later. From this point as well, it is favorable to use the EEPROM in which data can be rewritten in bit units.

When video data is received by the HDMI processing unit 110 via the HDMI terminal unit 111, the received video data is supplied to a first video data processing unit 122.

The first video data processing unit 122 performs interlace/progressive conversion in which interlaced video data which is inputted is converted into progressive video data, scaling in which a screen size of one frame (the number of pixels) is changed, and the like. These processing of the first video data processing unit 122 are selectively executed depending on a format of inputted video data.

The video data processed in the first video data processing unit 122 is supplied to a second video data processing unit 123. When the supplied video data is three-dimensional video data, the second video data processing unit 123 performs processing of separating the three-dimensional video data into left eye video data and right eye video data which constitute the three-dimensional video data. Though there is a plurality of formats for three-dimensional data, the second video data processing unit 123 performs processing which conforms to the format of the inputted three-dimensional video data. In the following description, three-dimensional video data for stereoscopic viewing is referred to as 3D video data. Further, video data for performing normal two-dimensional display may be referred to as 2D video data so as to be distinguished from 3D video data.

Further, the second video data processing unit 123 extracts synchronization data included in the 3D video data and generates 3D synchronization data (EMIT_Sync) which is to be supplied to an emitter device 200 which is an external device described later, so as to supply the 3D synchronization data to a LAN terminal unit 128. The 3D synchronization data is synchronization data for driving a liquid crystal shutter of stereoscopic image observation glasses that a user puts on for stereoscopic viewing.

Here, when inputted video data is 2D video data, the second video data processing unit 123 does not perform processing for 3D.

The video data processed in the second video data processing unit 123 is supplied to a video data adjustment unit 124. The video data adjustment unit 124 performs 3D gamma adjustment, display panel gamma adjustment, and the like so as to supply adjusted video data to a display panel driving unit 125.

The display panel driving unit 125 performs driving, which corresponds to the supplied video data, of a display panel 132. By this driving, an image is displayed on the display panel 132. The display panel 132 is a liquid crystal image display panel, for example. Light from a light source 131 is made incident on the display panel 132 and the light transmitted through this display panel 132 is projected on a screen (not depicted) by a projection lens 133. By projecting as this, the image displayed on the display panel 132 is displayed on the screen. Here, though one display panel is depicted as the display panel 132 in FIG. 1, individual panels for respective color components of a display image, for example, may be prepared. Further, a projector device employing a display system other than the liquid crystal display panel may be configured.

The first video data processing unit 122, the second video data processing unit 123, and the video data adjustment unit 124 can communicate with a control unit 121 via a bus line, and processing in the first video data processing unit 122, the second video data processing unit 123, and the video data adjustment unit 124 is executed on the basis of control of the control unit 121. To the control unit 121, a memory 127 is connected. In this memory 127, a program and data which are used by the control unit 121 to control each unit in the projector device 100 are stored.

In part of a storage region of the memory 127, data (EDID) 127a of a case where 2D video data can be inputted (that is, a case where input of 3D video data is not permitted) and data (EDID) 127b of a case where 3D video data can be inputted are stored. Either one of the data (EDID) 127a and 127b is stored in the EDID storage unit 112 which is described above, in accordance with an operation mode of the projector device 100. Details of processing of storing the data (EDID) 127a or 127b into the EDID storage unit 112 will be described later.

The data (EDID) 127b of a case where 3D video data can be inputted is data of an input format of video data which can be inputted through the HDMI terminal unit 111 when the projector device 100 is in an operation mode in which 3D display is possible. This data (EDID) 127b of a case where 3D video data can be inputted indicates not only a format of 3D video data which can be inputted but also data of a format of 2D video data which can be inputted.

On the other hand, the data (EDID) 127a of a case where 2D video data can be inputted is data of an input format of video data which can be inputted through the HDMI terminal unit 111 when the projector device 100 is in an operation mode in which 3D display is not permitted. This is a case where input of 3D video data is not permitted, so that only format data of 2D video data which can be inputted is indicated and consequently, it is indicated that input of 3D video data is not permitted.

The projector device 100 further includes a LAN terminal unit 128.

This LAN terminal unit 128 is a terminal unit for connecting the emitter device 200 which controls the liquid crystal shutter glasses, via a LAN cable 92. The LAN terminal unit 128 supplies 3D synchronization data (EMIT_Sync) and power (Power) to the LAN cable 92 which is connected. The 3D synchronization data (EMIT_Sync) is synchronization data which is separated from the 3D video data in the second video data processing unit 123. Further, as data inputted into the LAN terminal unit 128, there is detection data (EMIT_Detect) for detecting connection of the emitter device 200.

The emitter device 200 includes a LAN terminal unit 201, a synchronization extraction unit 202, and a transmission unit 203. The emitter device 200 extracts the 3D synchronization data (EMIT_Sync) which is received at the LAN terminal unit 201, at the synchronization extraction unit 202 so as to transmit the 3D synchronization data from the transmission unit 203 as an infrared signal. The infrared signal transmitted from the transmission unit 203 is received by liquid crystal shutter glasses 80 (refer to FIG. 3).

### [2. Configuration for Transmitting/Receiving via HDMI Cable]

A transmission procedure with respect to a device of the other side in a case where a HDMI cable 91 is connected to the HDMI terminal unit 111, which is a video data input unit of the projector device 100, is described with reference to FIG. 2. As described above, when device connection is performed with the HDMI cable 91, a device on an output side of video data is called a source device and a device on an input side of video data is called a sink device.

The projector device 100 is a sink device. FIG. 2 illustrates an example of a case where a source device 300 and the HDMI processing unit 110 of the projector device 100 are connected by the HDMI cable 91. Further, transmission channels of data are depicted and terminal units are not depicted in FIG. 2.

The source device 300 includes a source signal processing unit 301 which generates video data and audio data, and supplies video data, audio data, and control data which are outputted from the source signal processing unit 301 to a HDMI processing unit 302. The HDMI processing unit 302 arranges the video data, the audio data, and the control data in three channels which are TMDS channels 0, 1, and 2, in a divided manner and outputs data of each of the channels. Further, the HDMI processing unit 302 arranges a clock on a TMDS clock channel to output the clock. The data of each channel is transmitted by an individual line of the HDMI cable 91.

The HDMI processing unit 110 of the projector device 100 which is the sink device receives the data of TMDS channels 0, 1, and 2 and the data of the TMDS clock channel of the source device 300 and separates the data into video data, audio data, and control data. The video data, the audio data, and the control data which are obtained by the separation are supplied to respective units in the projector device 100. For example, the received video data is supplied to the first video data processing unit 122 depicted in FIG. 1. Further, the received control data is supplied to the control unit 121. Further, the received audio data is supplied to an audio data processing unit which is not depicted. When an audio data processing unit is not provided to the projector device 100, received audio data is not processed.

Further, as other lines for transmission via the HDMI cable 91, a display data channel (DDC) and a consumer electronics control (CEC) line are provided. Through these channel and line, bidirectional data transmission is performed. Through the display data channel, the HDMI processing unit 302 of the source device 300 reads out EDID stored in the EDID storage unit 112 of the projector device 100 which is the sink device. Further, by using the DDC, exchange of other data is also performed between the HDMI processing unit 302 of the source device 300 and the HDMI processing unit 110 of the sink device (projector device 100). Through the CEC line, bidirectional transmission of control data and the like is performed.

### [3. Connecting Configuration of Video Display Device and Emitter Device]

A connecting example of the projector device 100 which is the video display device and the emitter device 200 is now described with reference to FIG. 3. As illustrated in FIG. 3, one plug 92a of the LAN cable 92 is connected to the LAN terminal unit 128 of the projector device 100 and the other plug 92b of the LAN cable 92 is connected to the LAN terminal unit 201 of the emitter device 200. The LAN cable 92 can be set to be relatively long (for example, tens of meters) and therefore, the projector device 100 and the emitter device 200 can be placed away from each other.

An infrared signal IR transmitted by the emitter device 200 is received by the liquid crystal shutter glasses 80. The liquid crystal shutter glasses 80 set timing for opening/closing a left eye liquid crystal shutter and a right eye liquid crystal shutter on the basis of synchronization data included in the received infrared signal IR. By wearing such liquid crystal shutter glasses 80, a user who watches an image projected on the screen from the projector device 100 can have stereoscopic vision of a 3D image projected on the screen from the projector device 100. That is, the 3D image projected on the screen from the projector device 100 is an image which is obtained by alternately arranging left eye images and right eye images. The right eye shutter is closed at timing at which a left eye image is displayed and the left eye shutter is closed at timing at which a right eye image is displayed. Accordingly, the user wearing the liquid crystal shutter glasses 80 watches only the left eye images by his/her left eye and watches only the right eye images by his/her right eye, being able to have stereoscopic vision of the 3D image.

In a state that the emitter device 200 is not connected to the projector device 100, such control of the liquid crystal shutter glasses 80 is difficult, so that stereoscopic viewing of the 3D image is difficult. Accordingly, in the state that the emitter device 200 is not connected to the projector device 100, the projector device 100 functions as a display device which can display only 2D images.

FIG. 4 illustrates a wiring example in the LAN cable 92.

Among eight pins of the plug 92a, the first pin, the third pin, the fourth pin, and the sixth pin are respectively connected with an orange wiring, a black wiring, a brown wiring, and a red wiring. The seventh and eighth pins are short-circuited by a drain line, the first and second lines are short-circuited by a jumper line, and the seventh and eighth lines are short-circuited by a jumper line. The plug 92a on the projector device 100 side and the plug 92b on the emitter device 200 side connect corresponding wirings having the same numbers. Through the both plugs 92a and 92b having such configurations, power (Power) is supplied to the first pin and the second pin from the projector device 100 side. Further, the third pin acquires detection data (EMIT_Detect) from the emitter device 200. Furthermore, 3D synchronization data (EMIT_Sync) is transmitted from the projector device 100 side by using the fourth pin and strength setting data (EMIT_Strength) is transmitted by using the sixth pin. The seventh and eighth pins are connected to ground (GND).

The detection data (EMIT_Detect) is used for confirming that the emitter device 200 is connected to the projector device 100 by using the LAN cable 92. When the plug 92b is not connected to the LAN terminal unit 201 of the emitter device 200 (non-inserted time), the detection data (EMIT_Detect) becomes high (H), and when the plug 92b is inserted (inserted time), the detection data becomes low (L).

The 3D synchronization data (EMIT_Sync) is used for determining opening timing of the left eye shutter and the right eye shutter of the liquid crystal shutter glasses 80. The strength setting signal (EMIT_Strength) is a signal for setting the strength (=strength of an output signal of the infrared ray LED) of an infrared signal which is transmitted by the emitter device 200. When the strength of the output signal of the infrared ray LED is set large, the strength setting signal is set to be low (L), and when the strength is set small, the strength setting signal is set to be high (H).

### [4. Setting Processing of EDID]

Setting processing of EDID which is stored in the EDID storage unit 112 of the projector device 100 depicted in FIG. 1 is now described with reference to a flowchart of FIG. 5. Storage data of the EDID storage unit 112 is set under the control of the control unit 121. In the example of the embodiment, when the state of the projector device 100 changes from a power-off state (or a stand-by state) to a power-on state, the control unit 121 executes processing illustrated in the flowchart of FIG. 5. Here, since the EDID storage unit 112 is a nonvolatile memory, storage data of the EDID storage unit 112 at the power-on is storage data which has been set in the operation of the previous power-on.

The processing of the flowchart of FIG. 5 which is performed at the power-on time is described. First, the control unit 121 determines whether detection data (EMIT_Detect) acquired by the LAN terminal unit 128 is low (L) (step S11). The state that detection data (EMIT_Detect) is low (L) is a state that the emitter device 200 is connected to the projector device 100.

When the detection data (EMIT_Detect) is not low (L) in the determination of step S11 (that is, when the detection data is high), it is assumed that data stored in the EDID storage unit 112 is only format data of 2D video data (step S12).

Then, the control unit 121 reads out the storage data of the EDID storage unit 112 and compares the read-out storage data to format data of 2D video data (step S13). At this time, the format data of 2D video data which is compared with the storage data of the EDID storage unit 112 is obtained from the data (EDID) 127a which is prepared in the memory 127, for example. Then, whether the result of the comparison of step S13 indicates matching is determined (step S14).

When the matching is determined in step S14, the storage data of the EDID storage unit 112 is maintained as it is because data adapted to the state that the emitter device 200 is not connected is stored in the EDID storage unit 112 (step S15).

When mismatching is determined in step S14, EDID is not adapted to the state that the emitter device 200 is not connected, and therefore, the storage data of the EDID storage unit 112 is rewritten to EDID including only format data of 2D video data (step S16). In this rewriting, the control unit 121 reads out the data (EDID) 127a prepared in the memory 127 and updates the storage data of the EDID storage unit 112 with the read-out data.

By this update, such state is produced that EDID that is adapted to the state that the emitter device 200 is not connected and indicates that only 2D video data can be inputted is stored in the EDID storage unit 112.

Meanwhile, the case where the detection data (EMIT_Detect) is low (L) in the determination of step S11 represents a state that the emitter device 200 is connected, and processing from step S21 are performed. That is, it is assumed that data stored in the EDID storage unit 112 includes format data of 3D video data, after the determination of step S11 (step S21).

Then, the control unit 121 reads out storage data of the EDID storage unit 112 and compares the read-out storage data to format data for the case where 3D video data can be inputted (step S22). At this time, the format data, which is compared with the storage data of the EDID storage unit 112, for the case where 3D video data can be inputted is obtained from the data (EDID) 127b prepared in the memory 127, for example. Then, whether the result of the comparison in step S22 indicates matching is determined (step S23).

When the matching is determined in step S23, the storage data of the EDID storage unit 112 is maintained as it is because data adapted to the state that the emitter device 200 is connected is stored in the EDID storage unit 112 (step S24).

When mismatching is determined in step S23, EDID is not adapted to the state that the emitter device 200 is connected, and therefore, the storage data of the EDID storage unit 112 is rewritten to EDID of format data for the case where 3D video data can be inputted (step S25). In this rewriting, the control unit 121 reads out the data (EDID) 127b prepared in the memory 127 and updates the storage data of the EDID storage unit 112 with the read-out data.

By this update, such state is produced that EDID that is adapted to the state that the emitter device 200 is connected and indicates that 3D video data can be inputted is stored in the EDID storage unit 112.

Thus, according to the projector device 100 of the embodiment, when the emitter device 200 is connected via the LAN cable 92, EDID stored in the EDID storage unit 112 indicates that 3D video data can be inputted. This processing is performed at power activation time. Therefore, when the projector device 100 is powered on by the power activation, EDID becomes to correspond to a case where the emitter device 200 is connected and display processing of 3D video data is possible. Thus, the projector device 100 appropriately functions as the video display device which can display 3D video data.

When the emitter device 200 is not connected to the projector device 100 at the power-on time, EDID stored in the EDID storage unit 112 indicates that only 2D video data can be inputted and thus indicates that input of 3D video data is not permitted. Accordingly, in a state that the emitter device 200 is not connected, the display device accepts only 2D video data. Thus, the display device can prevent input of 3D video data in a state that stereoscopic viewing of a user is difficult. In other words, conversion processing from 3D video data to 2D video data which is commonly performed when 3D video data is inputted in a state that the stereoscopic viewing of the user is difficult is not performed. Accordingly, degradation of display image quality caused by the conversion of video data in the display device can be prevented.

### [5. Modification]

In the above-described example of the embodiment, the technique is applied to the projector device which projects an image on a screen as the video display device. On the other hand, the technique of the embodiment of the present disclosure may be applied to other video display device such as a liquid crystal display device and an organic electroluminescence (EL) display device of which a display panel is directly viewed by a user. Further, the video display device may be provided with an audio processing system to process audio data inputted into a HDMI terminal unit and the like and output the processed audio data from a speaker or the like.

Though an EEPROM is used as the memory constituting the EDID storage unit in the above-described embodiment, a nonvolatile memory having other configuration may be used.

For example, as the memory constituting the EDID storage unit, various nonvolatile memories such as a flash memory, a non volatile RAM (NVRAM), a ferroelectric RAM (FeRAM), and a magnetoresistive RAM (MRAM) may be used. An EEPROM and a flash memory are nonvolatile memories in which storage data can be electrically rewritten. A NVRAM is a nonvolatile memory provided with a memory backup battery. A FeRAM is a nonvolatile memory in which ferroelectric is used as a storage element and a MRAM is a nonvolatile memory in which a magnetic material is used as a storage element.

Further, in the example of the configuration depicted in FIG. 1, a dedicated memory is used as the EDID storage unit. However, the EDID storage unit may be configured by using part of a storage region of other nonvolatile memory which is provided to the video display device.

Though the processing of the flowchart depicted in FIG. 5 is performed at the power activation of the projector device which is the video display device, the processing illustrated in the flowchart of FIG. 5 may be performed during a display operation after the power activation as well. For example, a state of detection data (EMIT_Detect) is periodically checked during an operation of the video display device as well, and EDID is rewritten when detection data is changed. Accordingly, a case where the emitter device is attached or detached during the operation of the video display device can be handled as well. The check of detection data in this case may be irregularly performed at timing which is set at random.

Further, processing of regularly or irregularly checking detection data is performed after the processing at the power activation illustrated in the flowchart of FIG. 5 is performed. Alternatively, detection data may be regularly or irregularly checked after display is started without checking detection data at the power activation.

Further, though the terminal of the interface of the HDMI standard is used as a terminal for video input in the above-described example of the embodiment, a terminal unit of other standard may be employed. A terminal unit of other interface is applicable for data which is prepared in each interface and indicates a format of video data which can be inputted and the like.

Further, the LAN terminal unit to which the emitter device is connected may be a terminal unit which is connected with a cable other than the LAN cable. Alternatively, such configuration may be employed that the video display device and the emitter device are set to be able to perform bidirectional wireless communication, and the video display device wirelessly transmits synchronization data and detects a state that the video display device can wirelessly communicate with the emitter device, thus performing similar control.

The embodiment of the present disclosure may have the following configurations as well.

(1) A video display device includes
a first terminal unit configured to receive video data that is outputted by a source device and transmit data about a format of video data that can be inputted, to the source device,
a video data processing unit configured to display-process the video data received by the first terminal unit,
a display unit configured to display an image based on the video data that is processed by the video data processing unit,
a data storage unit configured to store data, which is outputted by the first terminal unit, about video data that can be inputted,
a second terminal unit configured to output synchronization data for performing three-dimensional display on the display unit, and
a control unit configured to perform control of storing data indicating that video data for three-dimensional display can be inputted, in the data storage unit in a case where an external device is connected to the second terminal unit, and control of storing data indicating that input of video data for three-dimensional display is not permitted, in the data storage unit in a case where the external device is not connected to the second terminal unit.

(2) In the video display device according to (1),
a nonvolatile memory is used as the data storage unit, and
the control unit determines presence/absence of connection of an external device to the second terminal unit at power activation, and updates storage data of the data storage unit in a case where data corresponding to the determined presence/absence of the connection of the external device is not stored in the data storage unit.

(3) In the video display device according to (1) or (2),
the control unit periodically or irregularly determines presence/absence of connection of an external device to the second terminal unit and updates storage data of the data storage unit on the basis of the determination.

(4) In the video display device according to any one of (1) to (3),
the first terminal unit is a terminal unit for an interface of a HDMI standard, and
data, which is transmitted to the source device by the first terminal unit, about video data that can be inputted is data of a display data channel.

(5) A video display method includes
first communication processing in which video data outputted by a source device is inputted via a first terminal unit and data about a format of video data that can be inputted is read out at the first terminal unit from a data storage unit so as to be outputted to the source device,
display processing in which display based on the video data that is obtained from the source device in the first communication processing is performed,
second communication processing in which synchronization data for performing three-dimensional display in the display processing is outputted to an external device, and
control processing in which data indicating that video data for three-dimensional display can be inputted is stored in the data storage unit in a case where an external device that performs the second communication processing is connected, and data indicating that input of video data for three-dimensional display is not permitted is stored in the data storage unit in a case where the external device is not connected.

The present disclosure contains subject matter related to that disclosed in Japanese Priority Patent Application JP 2011-158327 filed in the Japan Patent Office on Jul. 19, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video display device, comprising:
a first terminal unit configured to receive video data that is outputted by a source device and transmit data about a format of video data that can be inputted, to the source device;
a video data processing unit configured to display-process the video data received by the first terminal unit;
a display unit configured to display an image based on the video data that is processed by the video data processing unit;
a data storage unit configured to store data about video data that can be inputted, the data being outputted by the first terminal unit;
a second terminal unit configured to output synchronization data for performing three-dimensional display on the display unit; and
a control unit configured to perform control of storing data indicating that video data for three-dimensional display can be inputted, in the data storage unit in a case where an external device is connected to the second terminal unit, and control of storing data indicating that input of video data for three-dimensional display is not permitted, in the data storage unit in a case where the external device is not connected to the second terminal unit.

2. The video display device according to claim 1, wherein
a nonvolatile memory is used as the data storage unit, and
the control unit determines presence/absence of connection of an external device to the second terminal unit at power activation, and updates storage data of the data storage unit in a case where data corresponding to the determined presence/absence of the connection of the external device is not stored in the data storage unit.

3. The video display device according to claim 1, wherein the control unit periodically or irregularly determines presence/absence of connection of an external device to the second terminal unit and updates storage data of the data storage unit on the basis of the determination.

4. The video display device according to claim 1, wherein
the first terminal unit is a terminal unit for an interface of a HDMI standard, and
data about video data that can be inputted, the data being transmitted to the source device by the first terminal unit, is data of a display data channel.

5. A video display method, comprising:
first communication processing in which video data outputted by a source device is inputted via a first terminal unit and data about a format of video data that can be inputted is read out at the first terminal unit from a data storage unit so as to be outputted to the source device;
display processing in which display based on the video data that is obtained from the source device in the first: communication processing is performed;
second communication processing in which synchronization data for performing three-dimensional display in the display processing is outputted to an external device; and
control processing in which data indicating that video data for three-dimensional display can be inputted is stored in the data storage unit in a case where an external device that performs the second communication processing is connected, and data indicating that input of video data for three-dimensional display is not permitted is stored in the data storage unit in a case where the external device is not connected.
